(19) United States
(12) Patent Application Publication
(10) Pub. No.: US 2005/0287256 A1
(43) Pub. Date: Dec. 29, 2005

(54) Method for preparing food article

(76) Inventor: LeRoy A. Parker JR., Castaic Lake, CA (US)

Correspondence Address: BUTZEL LONG;DOCKETING DEPARTMENT, 100 BLOOMFIELD HILLS PARKWAY, SUITE 200, BLOOMFIELD HILLS, MI, 48304, US

(21) Appl. No.: 11/184,442

(22) Filed: Jul. 19, 2005

Related U.S. Application Data
(63) Continuation-in-part of application No. 10/373,109, filed on Feb. 26, 2003.
(60) Provisional application No. 60/359,311, filed on Feb. 26, 2002.

(51) Int. Cl. A23G 1/00

(52) U.S. Cl. 426/275

(57) ABSTRACT

A method for preparing meat products and a chip in a convenient and ready-to-eat form in a manner that is intended at preserving the meat flavor once part of the chip. The present invention provides an edible chip arrangement or similar foodstuff which includes a grain product such as wheat, rice, or corn, as well as a meat product sandwiched between at least two chips. The meat product can be a variety of types of meats, including, for example, pepperoni and beef jerky.

### CROSS-REFERENCE TO RELATED APPLICATIONS

This application is a continuation-in-part of U.S. patent application Ser. No. 10/373,109, filed Feb. 26, 2003, which claimed priority from U.S. Provisional Patent Application Ser. No. 60/359,311, filed Feb. 26, 2002.

### TECHNICAL FIELD

The present invention relates to a method for preparing a food article in the form of a taco-style snack. More particularly, the present invention relates to a taco-style snack having two spaced-apart chips having a meat filling therebetween.

### DISCUSSION

Some time ago edible chips established themselves as a highly desirable snack food for between-meal consumption. Chips offer the convenience of being ready-to-eat and readily storable.

On the other hand, the use of meant and meat products is primarily known for consumption during main courses. Traditionally, meat and meat products, when served at all, are served either as a main dish or as a part of a sandwich or similar food combination. In some cases the meat or meat product may be combined with other components.

A variety of patents relate to food processing in this area. These include U.S. Pat. Nos. 3,512,993, 3,642,496, 3,865,955, and 6,083,554.

Each of these patents discloses an advancement in the use of a meat or meat product in combination with another food to form a combined product. However, room is still available in the art for additional improvements in the form of a food article which includes meat or a meat product in a convenient, ready-to-eat form.

### SUMMARY OF THE INVENTION

The present invention is directed to the preparation of meat products and a chip in a convenient and ready-to-eat form, and in a manner that is intended at preserving the meat flavor once part of the chip. The present invention provides an edible chip arrangement or similar foodstuff which includes a grain product such as wheat, rice, or corn, as well as a meat product sandwiched between at least two chips. The meat product can be a variety of types of meats, including, for example, pepperoni and beef jerky.

Other objects and features of the present invention will become apparent as the description proceeds.

### BRIEF DESCRIPTION OF THE DRAWINGS

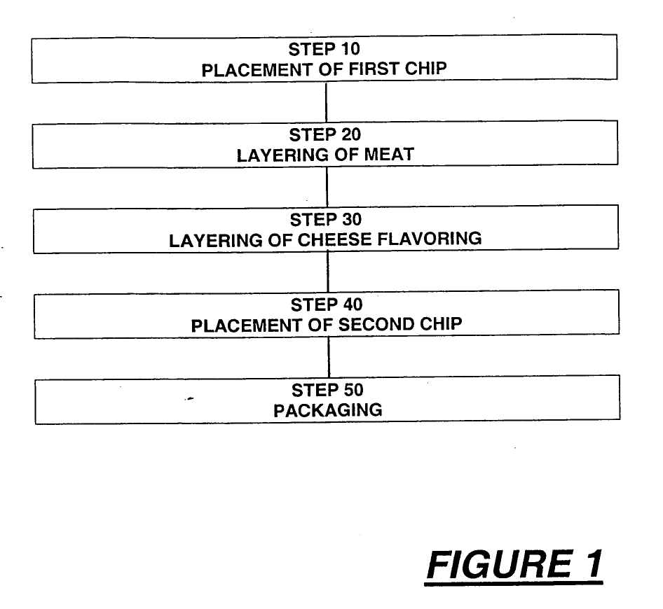

The present invention will be more fully understood by reference to the following detailed description of the preferred embodiments of the present invention when read in conjunction with the accompanying drawing, in which FIG. 1 is a flow diagram illustrating how the edible chip of the present invention may be prepared.

### DETAILED DESCRIPTION OF THE PREFERRED EMBODIMENTS

The drawing discloses the preferred embodiment for the production of the present edible chip invention. While the method of preparation according to the illustrated embodiment is preferred, it is envisioned that alternate methods of preparation of the present edible snack invention may be adopted without deviating from the invention as portrayed. The invention is best described by way of a specific example in which meat is used in the production of a snack.

At step 10, a squared or rounded corn chip of normal thickness are used. The size of the chip, if square, is approximately 1 to 1.5 inches on all sizes. Two chips are used. The chips may be flavored as desired.

At step 20, approximately one gram or so of soft jerky is used layered onto one of the two chips, this amount being enough to lay or spread across the corn chip. (A thin slice of jerky is about the thickness of a dime.) The jerky cannot be a thick bulky piece and should be along the lines of slice of meat on a sandwich. The jerky can be a processed beef spread or meat by-product, like turkey, chicken, or seafood. Whatever the choice, the meat must be soft enough to be able to be readily chewed.

At step 30, a soft, creamy and optionally flavored cheese that is substantially spreadable at room temperature is spread across the layer of meat. Different flavors and styles of cheese spread may be used, such as spicy, regular taco flavor, salsa and the like. Optionally, step 30 may be overlooked.

At step 40, the second chip is placed over the cheese-covered meat to form a sandwich-like cracker snack. The assembly is then pressed together gently but deliberately so as not to fall apart and so as not to commingle the meat and the_cheese spread, thereby defining relatively distinct layers of meat and cheese. (Along these lines, and as a variation of the process described, the cheese layer may be placed on both sides of the meat layer.)

At step 50, the assembled snack is placed with other assembled snacks into a package, such as a double-stacked grouping wrapped in a clear plastic.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings and the specification.

1. A method of making a food product comprising the steps of:
(1) preparing a quantity of chips to form a first component by selecting an amount of grain product, an amount of salt, an amount of water, and an amount of shortening, thereafter heating said shortening, and combining all of said grain product, said salt, said water, and said shortening to form a mixture, manipulating said mixture into plural pieces of selected shapes by first forming a ball then flattening said ball into a disc which is subsequently cut into the desired shapes for the chips;
(2) preparing a quantity of jerked meat to form a second component, said second component being a processed meat spread;
(3) applying said second component to a first chip to define a layer of processed meat spread;
(4) applying a selected amount of a creamy cheese that is substantially spreadable at room temperature onto said second component;
(5) placing a second chip on top of said selected amount of cheese to form the food product; and
(6) applying sufficient pressure to the food product so as to prevent the food product from falling apart but not so much pressure as to substantially commingle the meat and cheese.

2. The method of claim 1 in which said quantity of jerked meat is between 0.1 g and 10.0 g.

3. The method of claim 1 in which said selected amount of cheese is between 0.1 g and 10.0 g.

4. The method of claim 1 in which said grain product is corn.

5. The method of claim 1 in which said meat is beef.

6. The method of claim 1 in which said shortening is vegetable shortening.

7. The method of claim 1 in which said chips are between 0.1 cm and 0.5 cm thick and are between 2.0 cm and 4.0 cm wide.

8. A method of making a food product comprising the steps of:
(1) providing a pair of chips having a thickness of between 0.1 cm and 0.5 cm and a width of between 2.0 cm and 4.0 cm.
(2) providing a meat component in the amount of between 0.1 g and 10.0 g and placing said meat component on one of said pair of chips;
(3) providing a spreadable cheese component and spreading said cheese component on top of and beneath said meat component; and
(4) placing the other of said pair of chips on said cheese component such that defined layers of meat component and cheese component are maintained.

9. The method of claim 8 wherein said pair of chips are corn chips.

10. The method of claim 8 wherein said meat component is a jerked meat.

11. The method of claim 10 wherein said jerked meat is beef.
